(19) United States
(12) Patent Application Publication
(10) Pub. No.: US 2012/0105956 A1
(43) Pub. Date: May 3, 2012

(54) Flat Panel Display Device with Improved External Light Visibility

(75) Inventors: Hwan-Hee Jeong, Yongin-City (KR); Jung-Mok Park, Yongin-City (KR)

(73) Assignee: SAMSUNG MOBILE DISPLAY CO., LTD., Yongin-City (KR)

(21) Appl. No.: 13/069,868

(22) Filed: Mar. 23, 2011

(30) Foreign Application Priority Data
Oct. 27, 2010 (KR) 10-2010-0105404

(51) Int. Cl. G02B 5/30

(52) U.S. Cl. 359/488.01

(57) ABSTRACT

A display device comprises: a display module for displaying images; a window integrated touch panel disposed on an upper portion of the display module and spaced apart from the display module; and a polarizing plate disposed under the window integrated touch panel. The polarizing plate is disposed under the window integrated touch panel so as to allow the polarizing plate to absorb light incident on a lower portion of the polarizing plate while preventing the window integrated touch panel from being scattered to the display module due to external impact, thereby making it possible to improve external light visibility.

### CLAIM OF PRIORITY

This application makes reference to, incorporates the same herein, and claims all benefits accruing under 35 U.S.C. §119 from an application earlier filed in the Korean Intellectual Property Office on the 27 Oct. 2010 and there duly assigned Serial No. 10-2010-0105404.

### BACKGROUND OF THE INVENTION

1. Field of the Invention

The present invention relates generally to a display device and, more particularly, to a flat panel display having improved external light visibility.

2. Description of the Related Art

As a currently known flat panel display, there are a liquid crystal display (LCD), a plasma display panel (PDP), an organic light emitting diode (OLED) display, a field effect display (FED), an eletrophoretic display device, or the like.

These display devices are configured to include a display module for displaying images and a window spaced at a predetermined gap from the display module to protect the display module. An anti scattering film (ASF) is attached under the window in order to prevent the scattering of the window to the lower display module due to the damage of the window by external impact.

Furthermore, research into a display device additionally formed with a touch panel having a touch sensing function has been actively conducted recently. In particular, a window integrated touch panel in which the window is integrally formed with the touch panel has also been developed.

However, the display device including the window integrated touch panel is vulnerable to noise generated from the display module. To prevent this problem, a predetermined gap is disposed between the display module and the window integrated touch panel so that the thickness of the display device is thick. In addition, light generated from the display module transmits through the gap so as to be emitted to the outside, so that external light visibility, in terms of contrast and color reproduction under the external light due to the difference in refractive index between the window integrated touch panel and the gap and the degradation in transmittance caused by the gap, is deteriorated. Moreover, the external light is reflected from a surface of the window integrated touch panel and a surface of a polarizing plate of the display module, so that the external light visibility is further deteriorated.

The above information disclosed in this Background section is only for enhancement of an understanding of the background of the described technology, and therefore it may contain information which does not form the prior art which is already known in this country to a person of ordinary skill in the art.

### SUMMARY OF THE INVENTION

The present invention has been developed in an effort to provide a display device having the advantages of a small thickness and strong noise resistance, as well as improved external light visibility.

An exemplary embodiment of the invention provides a display device comprising: a display module for displaying images; a window integrated touch panel disposed on an upper portion of the display module so as to be spaced apart from the display module; and a polarizing plate attached under the window integrated touch panel.

The polarizing plate may include a polarizing member and a phase delay film disposed under the polarizing member, and the phase delay film may be a λ/4 phase delay film.

The display device may further include a noise shield layer attached under the polarizing plate, and the noise shield layer may be made of a transparent conductive material.

The noise shield layer and the display module may be spaced apart from each other with a predetermined gap therebetween.

The display device may further include an anti-reflective layer attached under the noise shield layer.

The display module may be a liquid crystal display module, a plasma display module, an organic light emitting display module, a field effect display module, or an eletrophoretic display module, and the external light may be reflected from the display module and absorbed in the polarizing plate.

According to exemplary embodiments of the invention, the polarizing plate is attached under the window integrated touch panel so as to allow the polarizing plate to absorb light incident on the lower portion of the polarizing plate while preventing the window integrated touch panel from being scattered to the display module due to external impact, thereby making it possible to improve the external light visibility.

In addition, the noise shield layer is attached under the polarizing plate so as to shield noise generated from the display module, thereby making it possible to reduce the gap between the display module and the window integrated touch panel.

Furthermore, the anti-reflective layer is attached under the noise shield layer, thereby making it possible to further improve the external light visibility.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view of a display device according to a first exemplary embodiment of the invention;

FIG. 2 is a cross-sectional view showing in detail a polarizing plate of FIG. 1;

FIG. 3 is a schematic diagram for explaining an operational principle of the display device of FIG. 1;

FIG. 4 is an equivalent circuit diagram of the display device according to the first exemplary embodiment of the invention; and

FIG. 5 is a cross-sectional view of a display device according to a second exemplary embodiment of the invention.

### DETAILED DESCRIPTION OF THE INVENTION

The present invention will now be described more fully with reference to the accompanying drawings, in which exemplary embodiments of the invention are shown. As those skilled in the art will realize, the described embodiments may be modified in various different ways, all without departing from the spirit or scope of the present invention. The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto. In the drawings, the thickness of layers, films, panels, regions, etc. are exaggerated for clarity. It will be understood that, when an element such as a layer, film, region or substrate is referred to as being “on” another element, it can be directly on the other element or intervening elements may also be present.

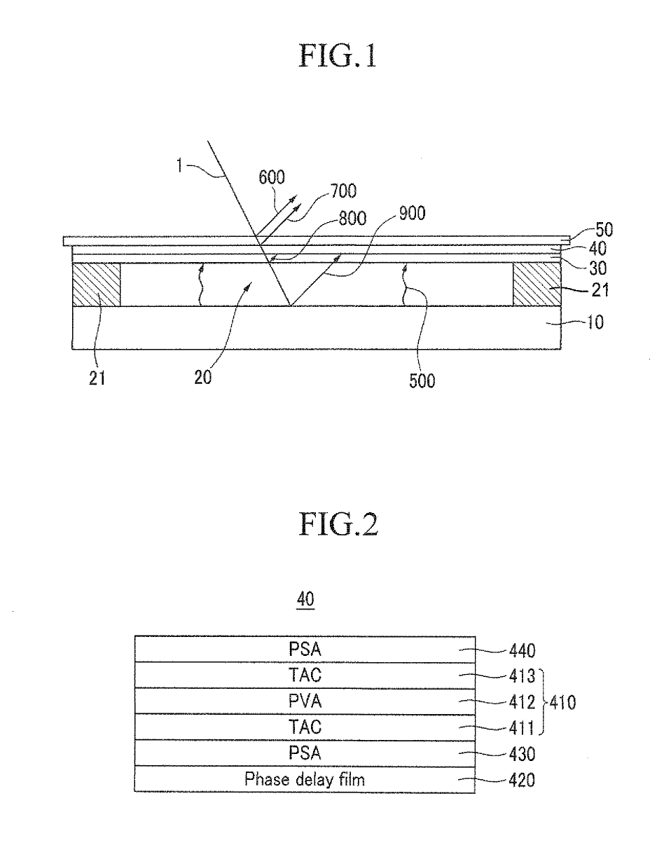

Hereinafter, a display device according to a first exemplary embodiment of the invention will be described in detail with reference to FIGS. 1 and 2.

FIG. 1 is a cross-sectional view of a display device according to a first exemplary embodiment of the invention, and FIG. 2 is a cross-sectional view showing in detail a polarizing plate of FIG. 1.

As shown in FIG. 1, the display device according to the first exemplary embodiment includes a display module 10 for displaying images, a window integrated touch panel 50 disposed on an upper portion of the display module 10 so as to be spaced apart from the display module 10, a polarizing plate 40 attached under the window integrated touch panel 50, and a noise shield layer 30 attached under the polarizing plate 40.

The display module 10 may be a liquid crystal display module, a plasma display module, an organic light emitting display module, a field effect display module, or an eletrophoretic display module.

A gasket 21 for sealing is formed along a peripheral portion above the display module 10, and the noise shield layer 30 is formed on the gasket 21. Therefore, a vacuum unit 20 is formed between the noise shield layer 30 and the display unit of the display module 10. The vacuum unit 20 serves to prevent an external impact applied to the window integrated touch panel 50 from being transferred to the display module 10.

In the window integrated touch panel 50, a window made of a transparent material such as glass, acryl or the like is integrally formed with a touch panel for touch sensing. The window serves to protect the display module 10, and the touch panel may be a resistive type touch panel or a capacitive type touch panel. Among others, a capacitive type touch panel is an apparatus which finds position coordinates by installing a film formed with a transparent electrode on a display module and applying voltage to each edge or each corner of the film so as to generate a uniform electric field to the transparent electrode in order to generate a voltage drop when any one point is touched by an input unit, such as a pen or a finger, or the like.

As shown in FIG. 2, the polarizing plate 40 includes a polarizing member 410 and a phase delay film 420 disposed under the polarizing member 410.

The polarizing member 410 includes a polarizer layer 412, and a lower support 411 and an upper support 413 for supporting the polarizer layer 412. The polarizer layer 412 may be made of polyvinyl alcohol (PVA), and the lower support 411 and the upper support 413 may be made of triacetyl cellulous (TAC).

The phase delay film 420 may be a λ/4 phase delay film and serves to convert linear polarization into circular polarization or circular polarization into linear polarization. The phase delay film 420 may include a birefringent film formed by performing a stretching process on a film made of a suitable polymer, such as polycarbonate, polyvinyl alcohol, polystylene, polymethyl methacrylate, polypropylene, or other polyolefin, polyarylate, polyamide or an alignment film of a liquid crystal polymer, a film supporting an alignment layer of a liquid crystal polymer, or the like.

The polarizing plate 40 serves as a circular polarizing plate since it is attached with the polarizing member 410 for linearly polarizing light in a predetermined direction, and a phase delay film 420 for converting linear polarization into circular polarization. Furthermore, the polarizing plate 40 serves to prevent the window integrated touch panel 50 from being scattered to the display module by external impact.

Most of the external light 1 (FIG. 1) transmits through the window integrated touch panel 50 and some portion 600 thereof is reflected therefrom. Most of the external light 1 transmitted through the window integrated touch panel 50 transmits through the polarizing plate 40 and some portion 700 thereof is reflected therefrom. Most of the external light 1 transmitted through the polarizing plate 40 is transmitted through the noise shield layer 30, and some portion 800 thereof is reflected from the bottom surface of the noise shield layer 30. The external light 1 transmitted through the noise shield layer 30 is reflected from the display module 10, and the reflected external light is absorbed in the polarizing plate 40. Therefore, light incident on the lower portion of the polarizing plate 40 is absorbed in the polarizing plate 40, thereby making it possible to improve the external light visibility.

A first adhesive layer 440 (see FIG. 2) is formed between the polarizing member 410 and the window integrated touch panel 50, thereby mutually bonding the polarizing member 410 and the window integrated touch panel 50. A second adhesive layer 430 is formed between the polarizing member 410 and the phase delay film 420, thereby mutually bonding the polarizing member 410 to the phase delay film 420. The first adhesive layer 440 and the second adhesive layer 430 are formed in a film type, including an adhesive as a pressure sensitivity adhesive (PSA) layer, and perform a bonding operation in response to pressure provided from the outside. An example of the adhesive may include an acryl-based or rubber-based adhesive having a refractive index in the range of 1.46 to 1.52, or an adhesive which includes particulates, such as zirconia, etc., in order to control the refractive index in the adhesive.

When driving the display module, the noise shield layer 30 for shielding noise generated from a driving integrated circuit (IC), a signal line, etc. is attached under the polarizing plate 40. The noise shield layer 30 may be made of a transparent conductive material, such as indium-tin oxide (ITO) or indium-zinc oxide (IZO).

As described above, the polarizing plate 40 is attached under the window integrated touch panel 50 so as to allow the polarizing plate 40 to absorb light incident on the lower portion of the polarizing plate 40 while preventing the window integrated touch panel 50 from being scattered to the display module 10 due to external impact, thereby making it possible to improve the external light visibility.

Furthermore, the noise shield module 30 is attached under the polarizing plate 40 so as to shield noise generated from the display module 10, thereby making it possible to improve the performance of the window integrated touch panel 50. In the related art, a predetermined gap is formed between the display module 10 and the window integrated touch panel 50 so as to prevent the noise generated from the display module 10 from arriving at the window integrated touch panel 50 but, when the noise shield layer 30 is attached, the gap between the display module 10 and the window integrated touch panel 50 may be reduced.

In addition, even in the case of a display device including the window integrated touch panel 50 having a driving IC sensitive to noise (for example, a synaptics IC), the noise shielding layer 30 is attached under the polarizing plate 40, thereby making it possible to shield an effect due to noise. Therefore, various driving ICs may be applied to the window integrated touch panel 50.

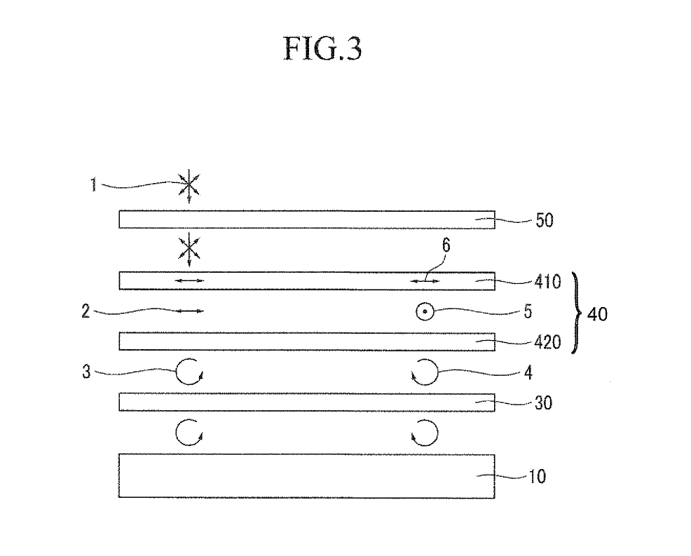

An operational principle wherein the display device shown in FIGS. 1 and 2 improves external light visibility will be described below in detail with reference to FIG. 3.

FIG. 3 is a schematic diagram for explaining an operational principle of the display device of FIG. 1.

As shown in FIG. 3, external light 1 transmits through the window integrated touch panel 50 and is incident on the polarizing member 410 of the polarizing plate 40. In this case, the polarizing member 410 absorbs some of the external light 1, and the remainder of the external light 1 is linearly polarized in the direction of a transmitting axis 6 of the polarizing member 410. The linearly polarized external light 2 is left-circularly polarized while transmitting through a λ/4 phase delay film 420. The left-circularly polarized external light 3 transmits through the noise shield layer 30 and is reflected from a reflective electrode (not shown) of the display module 10 so as to be right-circularly polarized. The right-circularly polarized external light 4 is linearly-polarized while transmitting through the λ/4 phase delay film 420 again. In this case, the polarizing axis of the linear polarization 5 is orthogonal to the transmitting axis 6 of the polarizing member 410, such that the linear polarization 5 is absorbed in the polarizing member 410.

As described above, the polarizing plate 40 is attached under the window integrated touch panel 50 so as to allow the polarizing plate 40 to absorb light incident on the lower portion of the polarizing plate 40, while preventing the window integrated touch panel 50 from being scattered to the display module 10 due to external impact, thereby making it possible to improve the external light visibility.

An organic light emitting display module in the display module 10 will now be described below in detail.

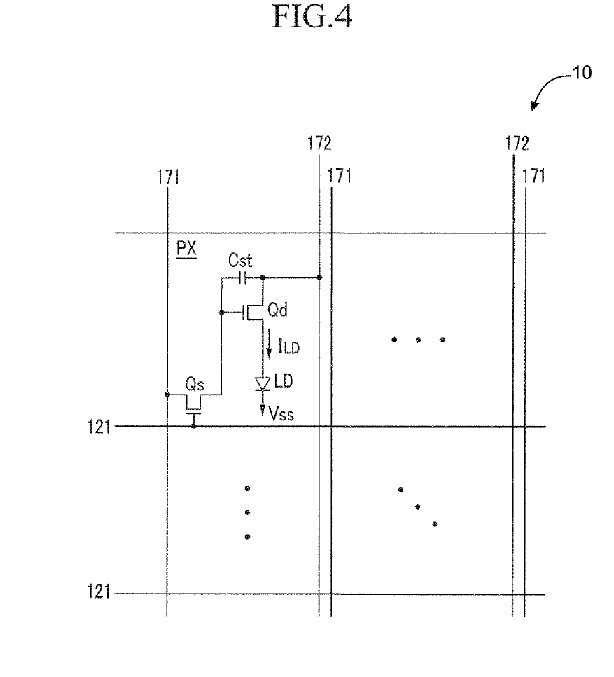

FIG. 4 is an equivalent circuit diagram of the display device according to the first exemplary embodiment of the invention.

As shown in FIGS. 3 and 4, the organic light emitting display module 10 includes a plurality of signal lines 121, 171 and 172, and a plurality of pixels (PX) connected thereto and arranged in an approximate matrix.

The signal lines 121, 171 and 172 include a plurality of gate lines 121 for transferring gate signals (or scanning signals), a plurality of data lines 171 for transferring data signals, and a plurality of driving voltage lines 172 for transferring a driving voltage. The gate lines 121 extend in an approximate row direction and are approximately parallel with each other, and the data lines 171 and the driving voltage lines 172 extend in an approximate column direction and are approximately parallel with each other.

Each pixel PX includes a switching thin film transistor Qs, a driving thin film transistor Qd, a storage capacitor Cst, and an organic light emitting diode (OLED) LD.

The switching thin film transistor Qs has a control terminal, an input terminal, and an output terminal, wherein the control terminal is connected to the gate line 121, the input terminal is connected to the data line 171, and the output terminal is connected to the driving thin film transistor Qd. The switching thin film transistor Qs transfers data signals applied to the data line 171 to the driving thin film transistor Qd in response to scanning signals applied to the gate line 121.

The driving thin film transistor Qd includes a control terminal, an input terminal, and an output terminal, wherein the control terminal is connected to the switching thin film transistor Qs, the input terminal is connected to a driving voltage line 172, and the output terminal is connected to the organic light emitting diode LD. The driving thin film transistor Qd produces an output current I_{LD} having a different size according to the voltage applied between the control terminal and the output terminal.

The capacitor Cst is connected between the control terminal and the input terminal of the driving thin film transistor Qd. The capacitor Cst charges the data signals applied to the control terminal of the driving thin film transistor Qd, and maintains it after the switching thin film transistor Qs is turned-off.

The organic light emitting diode LD has an anode connected to the output terminal of the driving thin film transistor Qd and a cathode connected to a common voltage Vss. The organic light emitting diode LD varies its own intensity according to the output current I_{LD} of the driving thin film transistor Qd so as to emit light, thereby displaying images.

The switching thin film transistor Qs and the driving thin film transistor Qd are each an n-channel field effect transistor (FET). However, at least one of the switching thin film transistor Qs and the driving thin film transistor Qd may be a p-channel field effect transistor. In addition, the connection relationship among the thin film transistors Qs and Qd, the capacitor Cst, and the organic light emitting diode LD may be changed.

The anode or the cathode of the organic light emitting display module 10 serves as a reflective electrode reflecting the external light 1.

The anti-reflective layer is attached under the noise shield layer, thereby making it possible to further improve the external light visibility.

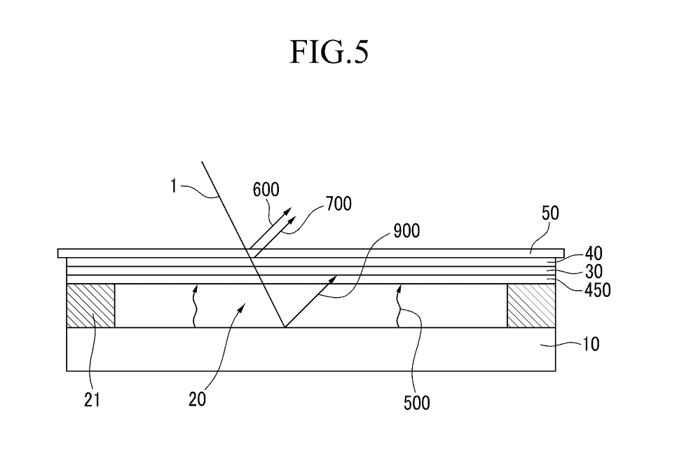

The display device according to a second exemplary embodiment of the invention will now be described below in detail with reference to FIG. 5.

FIG. 5 is a cross-sectional view of the display device according to a second exemplary embodiment of the invention.

The second exemplary embodiment is substantially the same as the first exemplary embodiment shown in FIG. 1, except for an anti-reflective layer, and therefore the repetitive description will be omitted.

As shown in FIG. 5, the anti-reflective layer 450 is formed under the noise shield layer 30. The anti-reflective layer 450 may be an acetate-based resin film, such as a triacetylcellouse or a triacetylcellouse film, the surface of which is saponificated with alkali, etc.

The anti-reflective layer 450 prevents the portion 800 (see FIG. 1) of the external light 1 transmitting through the polarizing plate 40 from being reflected from the bottom surface of the noise shield layer 30. In addition, the anti-reflective layer 450 serves to prevent the noise shield layer 30 from being damaged due to scratches, etc.

While this disclosure has been described in connection with what is presently considered to be practical exemplary embodiments, it is to be understood that the invention is not limited to the disclosed embodiments but, on the contrary, is intended to cover various modifications and equivalent arrangements included within the spirit and scope of the appended claims.

What is claimed is:

1. A display device, comprising:
a display module for displaying images;
a window integrated touch panel disposed above an upper portion of the display module and spaced apart from the display module; and
a polarizing plate disposed on the window integrated touch panel.

2. The display device of claim 1, wherein the polarizing plate comprises a polarizing member and a phase delay film

3. The display device of claim 2, wherein the phase delay film is a λ/4 phase delay film.

4. The display device of claim 2, further comprising a noise shield layer.

5. The display device of claim 4, wherein the noise shield layer is made of a transparent conductive material.

6. The display device of claim 4, wherein the noise shield layer and the display module are spaced apart from each other with a predetermined gap therebetween.

7. The display device of claim 4, further comprising an anti-reflective layer.

8. The display device of claim 4, wherein the phase delay film is disposed between the polarizing member and noise shield layer.

9. The display device of claim 8, wherein external light is reflected from the display module and is absorbed in the polarizing plate.

10. The display device of claim 4, further comprising an anti-reflective layer disposed under the noise shield layer.

11. The display device of claim 1, wherein the display module is any one selected from a liquid crystal display module, a plasma display module, an organic light emitting display module, a field effect display module, and an eletrophoretic display module.

12. The display device of claim 1, wherein external light is reflected from the display module and is absorbed in the polarizing plate.

13. The display device of claim 1, further comprising a noise shield layer disposed under the polarizing plate.

14. The display device of claim 13, wherein the noise shield layer is made of a transparent conductive material.

15. The display device of claim 13, wherein the noise shield layer and the display module are spaced apart from each other with a predetermined gap therebetween.

16. The display device of claim 13, further comprising an anti-reflective layer disposed under the noise shield layer.

17. The display device of claim 1, wherein the polarizing plate comprises a polarizing member which includes an upper support, a lower support, and a polarizing layer disposed between the upper support and the lower support.

18. The display device of claim 17, wherein the polarizing plate further comprises an adhesive layer disposed between the upper support and the window integrated touch panel.

19. The display device of claim 18, wherein the polarizing plate further comprises a phase delay film disposed under the lower support.

20. The display device of claim 1, wherein the polarizing plate comprises a polarizing member, an adhesive layer disposed between the polarizing member and the window integrated touch panel, and a phase delay film disposed under the polarizing member.
